(19) United States
(12) Patent Application Publication
(10) Pub. No.: US 2022/0306142 A1
(43) Pub. Date: Sep. 29, 2022

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventors: Shotaro Taniguchi, Wako-shi (JP); Atsuhiro Sekikawa, Wako-shi (JP)

(21) Appl. No.: 17/680,401

(22) Filed: Feb. 25, 2022

(30) Foreign Application Priority Data
Mar. 29, 2021 (JP) 2021-055442

(51) Int. Cl. B60W 50/14; B60K 35/00; B60W 60/00; B60W 30/09; G06V 20/58

(52) U.S. Cl. CPC B60W 50/14; B60K 35/00; B60W 60/005; B60W 30/09; G06V 20/58; B60K 2370/1868; B60K 2370/178; B60K 2370/52; B60K 2370/736; B60W 2720/106; B60W 2540/225; B60W 2554/802; B60W 2710/20; B60W 2050/146; B60W 2420/42; B60W 2420/52; G06K 9/6288

(57) ABSTRACT

A driving assistance device of an embodiment includes a recognizer that recognizes a state of a surrounding object that is an object present in the surroundings of a vehicle and a traveling status of the vehicle, a detector that detects a first direction that is a direction of a line of sight of a driver of the vehicle, a determiner that determines whether or not the surrounding object is a target object to be watched by the driver on the basis of the state of the surrounding object and the traveling status, and a display controller that, in a case where it is determined that the surrounding object is the target object, displays first information for guiding the line of sight of the driver toward the target object on one or a plurality of displays on the basis of the first direction detected by the detector and a second direction in which the target object is present when viewed from the driver, in which the display controller determines at least one display to display the first information from among the plurality of displays on the basis of the first direction detected by the detector, or determines a mode of the first information to be displayed on the display.

### CROSS-REFERENCE TO RELATED APPLICATION

This application is based upon and claims the benefit of priority from Japanese Patent Application No. 2021-055442, filed Mar. 29, 2021, the entire contents of which is incorporated herein by reference.

### BACKGROUND

### Field of the Invention

The present invention relates to a driving assistance device, a driving assistance method, and a storage medium.

### Description of Related Art

There is a technique for displaying information such as an arrow on a heads-up display according to a direction in which a driver's line of sight is directed (refer to, for example, Japanese Unexamined Patent Application, First Publication No. 2018-22349).

### SUMMARY

However, in the technique of the related art, since the heads-up display is located at a fixed position, a driver moves his/her line of sight from a direction in which the line of sight is being currently directed to the heads-up display, and then checks information displayed on the heads-up display. As a result, there may be a delay in checking a target object to be watched.

One aspect of the present invention has been made in consideration of such circumstances, and one object thereof is to provide a driving assistance device, a driving assistance method, and a storage medium enabling a driver to check a target object more quickly.

A driving assistance device, a driving assistance method, and a storage medium according to the present invention have the following configurations.

According to one aspect (1) of the present invention, a driving assistance device is provided including a recognizer that recognizes a state of a surrounding object that is an object present in the surroundings of a vehicle and a traveling status of the vehicle; a detector that detects a first direction that is a direction of a line of sight of a driver of the vehicle; a determiner that determines whether or not the surrounding object is a target object to be watched by the driver on the basis of the state of the surrounding object and the traveling status recognized by the recognizer; and a display controller that, in a case where the determiner determines that the surrounding object is the target object, displays first information for guiding the line of sight of the driver toward the target object on one or a plurality of displays on the basis of the first direction detected by the detector and a second direction in which the target object is present when viewed from the driver, in which the display controller determines at least one display to display the first information from among the plurality of displays on the basis of the first direction detected by the detector, or determines a mode of the first information to be displayed on the display.

According to an aspect (2), in the driving assistance device of the above aspect (1), the display controller determines the at least one display to display the first information from among the plurality of displays or determines the mode of the display to be displayed on the display on the basis of a movement path of the line of sight from the first direction to the second direction.

According to an aspect (3), in the driving assistance device of the above aspect (1) or (2), in a case where the driving mode of the vehicle is the manual driving mode, the display controller displays the first information and second information for notifying the driver of a manual driving operation to be performed by the driver on the display.

According to an aspect (4), in the driving assistance device of any one of the above aspects (1) to (3), in a case where the driving mode of the vehicle is a driving assistance mode in which the driver is required to monitor the front in the vehicle, the display controller displays the first information, second information for notifying the driver of a manual driving operation to be performed by the driver, and third information for requesting the driver to drive the vehicle on the display.

According to an aspect (5), in the driving assistance device of any one of the above aspects (1) to (4), in a case where the driving mode of the vehicle is an automated driving mode in which the driver is not required to monitor the front in the vehicle, the display controller displays the first information on the display, and, in a case where the driving mode of the vehicle is the automated driving mode, the determiner determines whether or not the driver has directed his/her line of sight to the target object on the basis of the first direction detected by the detector after the first information is displayed on the display and the second direction.

According to an aspect (6), the driving assistance device of the above aspect (5) further includes a driving controller that controls at least one of a speed and steering of the vehicle, in which, under the automated driving mode, in a case where the determiner determines that the driver has not directed his/her line of sight to the target object and a relative positional relationship between the vehicle and the target object satisfies a predetermined condition, the driving controller decelerates the vehicle.

According to an aspect of (7), in the driving assistance device of the above aspect (5) or (6), under the automated driving mode, in a case where the determiner determines that the driver has directed his/her line of sight to the target object, the display controller displays the first information, second information for notifying the driver of a manual driving operation to be performed by the driver, and third information for requesting the driver to drive the vehicle on the display.

According to an aspect (8), the driving assistance device of the above aspect (4) or (7) further includes a driving controller that controls at least one of a speed and steering of the vehicle, in which, in a case where driving of the vehicle is not replaced by that of the driver after the third information is displayed on the display, and a relative positional relationship between the vehicle and the target object satisfies a predetermined condition, the driving controller decelerates the vehicle.

According to an aspect (9), in the driving assistance device of the above aspect (8), in a case where the driving of the vehicle is replaced by that of the driver after the third information is displayed on the display, the display controller displays the first information and the second information on the display.

According to an aspect (10), the driving assistance device of the above aspect (3) or (9) further includes a driving controller that controls at least one of a speed and steering of the vehicle, in which, in a case where a relative positional relationship between the vehicle and the target object satisfies a predetermined condition after the first information and the second information are displayed on the display, the driving controller decelerates the vehicle.

According to another aspect (11) of the present invention, a driving assistance method is provided causing a computer mounted on a vehicle to recognize a state of a surrounding object that is an object present in the surroundings of the vehicle and a traveling status of the vehicle; detect a first direction that is a direction of a line of sight of a driver of the vehicle; determine whether or not whether or not the surrounding object is a target object to be watched by the driver on the basis of the state of the surrounding object and the traveling status; in a case where it is determined that the surrounding object is the target object, display first information for guiding the line of sight of the driver toward the target object on one or a plurality of displays on the basis of the first direction and a second direction in which the target object is present when viewed from the driver; and determine at least one display to display the first information from among the plurality of displays on the basis of the first direction, or determine a mode of the first information to be displayed on the display.

According to still another aspect (12) of the present invention, a non-transitory storage medium is provided storing computer-readable instructions for causing a computer mounted on a vehicle to execute recognizing a state of a surrounding object that is an object present in the surroundings of the vehicle and a traveling status of the vehicle; detecting a first direction that is a direction of a line of sight of a driver of the vehicle; determining whether or not whether or not the surrounding object is a target object to be watched by the driver on the basis of the state of the surrounding object and the traveling status; in a case where it is determined that the surrounding object is the target object, displaying first information for guiding the line of sight of the driver toward the target object on one or a plurality of displays on the basis of the first direction and a second direction in which the target object is present when viewed from the driver; and determining at least one display to display the first information from among the plurality of displays on the basis of the first direction, or determining a mode of the first information to be displayed on the display.

According to any of the above aspects, a driver can check a target object more quickly.

### BRIEF DESCRIPTION OF THE DRAWINGS

FIG. 1 is a configuration diagram of a vehicle system using a driving assistance device according to an embodiment.

FIG. 2 is a diagram schematically showing the inside of an own vehicle.

FIG. 3 is a diagram schematically showing the inside of the own vehicle.

FIG. 4 is a functional configuration diagram of a first controller and a second controller.

FIG. 5 is a diagram showing an example of a correspondence relationship between a driving mode, a control state of an own vehicle M, and a task.

FIG. 6 is a diagram for describing a method of guiding a driver's line of sight.

FIG. 7 is a diagram for describing a method of guiding the driver's line of sight.

FIG. 8 is a diagram showing an example of a display mode of a line-of-sight guidance object.

FIG. 9 is a flowchart showing an example of a flow of a series of processes performed by the automated driving control device of the embodiment.

FIG. 10 is a flowchart showing an example of a flow of a series of processes performed by an automated driving control device of the embodiment.

FIG. 11 is a flowchart showing an example of a flow of a series of processes performed by the automated driving control device of the embodiment.

FIG. 12 is a flowchart showing an example of a flow of a series of processes performed by the automated driving control device of the embodiment.

FIG. 13 is a diagram showing examples of a line-of-sight guidance object and a driving operation object.

FIG. 14 is a diagram showing an example of a takeover request.

FIG. 15 is a diagram showing an example of alerting.

FIG. 16 is a diagram showing an example of a hardware configuration of the automated driving control device of the embodiment.

### DESCRIPTION OF EMBODIMENTS

Hereinafter, embodiments of a driving assistance device, a driving assistance method, and a storage medium of the present invention will be described with reference to the drawings.

Overall Configuration

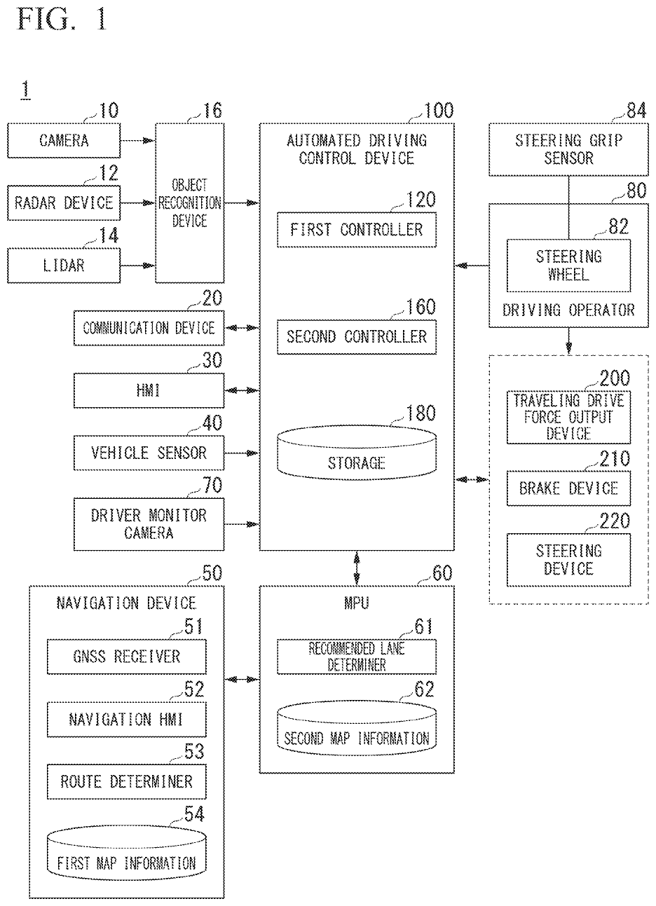

FIG. 1 is a configuration diagram of a vehicle system 1 using a driving assistance device according to an embodiment. A vehicle (hereinafter, an own vehicle M) having the vehicle system 1 mounted therein is, for example, a two-wheeled, three-wheeled, or four-wheeled vehicle, and a drive source thereof is an internal combustion engine such as a diesel engine or a gasoline engine, a motor, or a combination thereof. The motor is operated by using power generated by a generator connected to the internal combustion engine or power released from a secondary battery or a fuel cell.

The vehicle system 1 includes, for example, a camera 10, a radar device 12, light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an automated driving control device 100, a traveling drive force output device 200, a brake device 210, and a steering device 220. The devices and the apparatuses are connected to each other via a multiplex communication line such as a Controller Area Network (CAN) communication line, a serial communication line, or a wireless communication network. The configuration shown in FIG. 1 is only an example, and some of the constituents may be omitted, and other constituents may be added. The automated driving control device 100 is an example of a “driving assistance device”.

The camera 10 is a digital camera using a solid-state imaging element such as a charge coupled device (CCD) or a complementary metal oxide semiconductor (CMOS). The camera 10 is attached at any location in a vehicle in which the vehicle system 1 is mounted. For example, in a case of imaging the front in the own vehicle M, the camera 10 is attached to the upper part of a front windshield, the back surface of a rearview mirror, or the like. In a case of imaging the rear of the own vehicle M, the camera 10 is attached to the upper part of a rear windshield or the like. In a case of imaging the right side or the left side of the own vehicle M, the camera 10 is attached to a vehicle body or a right-side surface or a left side surface of a door mirror. The camera 10 periodically and repeatedly captures images of the periphery of the own vehicle M. The camera 10 may be a stereo camera.

The radar device 12 radiates electric waves such as millimeter waves in the surroundings of the own vehicle M, detects electric waves (reflected waves) reflected by an object, and thus detects at least a position of (a distance to and an azimuth of) the object. The radar device 12 is attached at any location in the own vehicle M. The radar device 12 may detect a position and a speed of an object according to a frequency modulated continuous wave (FM-CW) method.

The LIDAR 14 applies light (or an electromagnetic wave with a wavelength close to that of the light) in the surroundings of the own vehicle M, and measures scattered light. The LIDAR 14 detects a distance to a target on the basis of a time from light emission to light reception. The applied light is, for example, pulsed laser light. The LIDAR 14 is attached at any location in the own vehicle M.

The object recognition device 16 performs a sensor fusion process on detection results from some or all of the camera 10, the radar device 12, and the LIDAR 14, and thus recognizes a position, the type (attribute), a speed, and the like of an object. The object recognition device 16 outputs a recognition result to the automated driving control device 100. The object recognition device 16 may output detection results from the camera 10, the radar device 12, and the LIDAR 14 to the automated driving control device 100 without change. The object recognition device 16 may be omitted from the vehicle system 1.

The communication device 20 performs communication with another vehicle present in the surroundings of the own vehicle M or performs communication with various server apparatuses via a wireless base station by using, for example, a cellular network, a Wi-Fi network, Bluetooth (registered trademark), or dedicated short range communication (DSRC).

The HMI 30 presents various types of information to an occupant (including a driver) of the own vehicle M, and also receives an input operation from the occupant. The HMI 30 includes a display device 32.

The display device 32 includes a heads-up display (HUD) 32A, an instrument panel display 32B, a display meter 32C, a center display 32D, and the like. The instrument panel display 32B, the display meter 32C, and the center display 32D are, for example, a liquid crystal displays (LCDs) or an organic electroluminescence (EL) displays. The HMI 30 may further include a speaker, a buzzer, a touch panel, a switch, a button, and the like. For example, the occupant inputs a destination of the own vehicle M to the HMI 30.

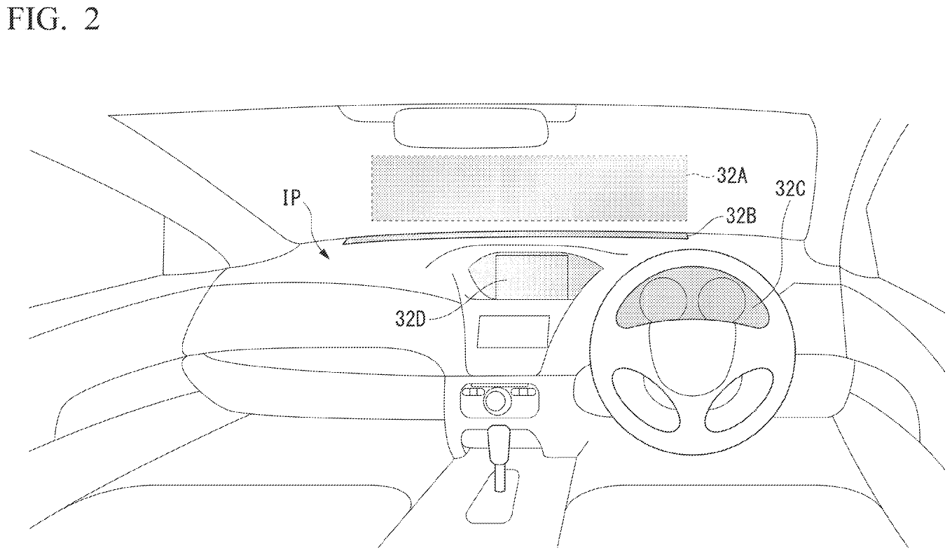

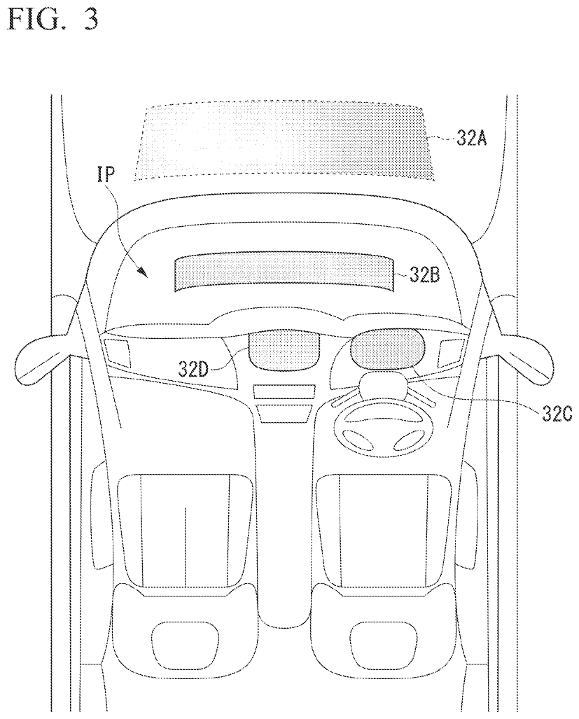

FIGS. 2 and 3 are diagrams schematically showing the inside of the own vehicle M. The HUD 32A is a display that displays (projects) various images or videos as virtual images on the front window shield. The instrument panel display 32B is a display that is installed on an instrument panel IP and displays various images or videos. The display meter 32C is a display that is provided on the instrument panel IP near the front in the driver seat and is visible to a driver through the gap of the steering wheel 82 or through the steering wheel 82. The center display 32D is provided at the center of the instrument panel IP. The center display 32D may be used as a navigation HMI 52 that will be described later. Instead of the HUD 32A, the front window shield of the own vehicle M may be used as one display. In this case, for example, a light emitting diode (LED) incorporated in the instrument panel IP is made to emit light, and the LED light is reflected by the front window shield to display information visible to the driver on the front window shield.

FIG. 1 will be referred to again. The vehicle sensor 40 includes a vehicle speed sensor that detects a speed of the own vehicle M, an acceleration sensor that detects acceleration, a gyro sensor that detects angular velocity, an azimuth sensor that detects the orientation of the own vehicle M, and the like. The gyro sensor may include, for example, a yaw rate sensor that detects an angular velocity about a vertical axis.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory.

The GNSS receiver 51 receives electric waves from each of a plurality of GNSS satellites (artificial satellites) and specifies a position of the own vehicle M on the basis of signals of the received electric waves. The GNSS receiver 51 outputs the specified position of the own vehicle M to the route determiner 53, or outputs the position directly to the automated driving control device 100 or indirectly via the MPU 60. The position of the own vehicle M may be specified or complemented by an inertial navigation system (INS) using an output from the vehicle sensor 40.

The navigation HMI 52 includes a display device, a speaker, a touch panel, keys, and the like. The navigation HMI 52 may be partially or entirely integrated into the HMI 30 described above. For example, an occupant may enter a destination of the own vehicle M to the navigation HMI 52 instead of or in addition to inputting the destination of the own vehicle M to the HMI 30.

The route determiner 53 determines, for example, a route (hereinafter, a route on a map) from a position of the own vehicle M specified by the GNSS receiver 51 (or any entered position) to a destination that is entered by an occupant by using the HMI 30 or the navigation HMI 52 on the basis of the first map information 54.

The first map information 54 is, for example, information in which a road shape is expressed by a link indicating a road and nodes connected to each other via the link. The first map information 54 may include a curvature of a road, point of interest (POI) information, and the like. The route on the map is output to MPU60.

The navigation device 50 may perform route guidance using the navigation HMI 52 on the basis of the route on the map. The navigation device 50 may be implemented, for example, by a function of a terminal apparatus such as a smartphone or a tablet terminal carried by the occupant. The navigation device 50 may transmit the current position and the destination to a navigation server via the communication device 20 and may acquire a route equivalent to the route on the map from the navigation server.

The MPU 60 includes, for example, a recommended lane determiner 61, and stores second map information 62 in a storage device such as an HDD or a flash memory. The recommended lane determiner 61 is realized by a hardware processor such as a central processing unit (CPU) executing a program (software). The recommended lane determiner 61 may be realized by hardware (a circuit portion; including circuitry) such as a large-scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) of the MPU 60 and may be stored in an attachable and detachable storage medium such as a DVD or a CD-ROM and may be installed in the storage device of the MPU 60 when the storage medium (non-transitory storage medium) is attached to a drive device.

The recommended lane determiner 61 divides the route on the map provided from the navigation device 50 into a plurality of blocks (for example, divides the route on the map every 100 m in a vehicle advancing direction) and determines a recommended lane for each block by referring to the second map information 62. The recommended lane determiner 61 determines in which lane from the left the own vehicle will travel. In a case where there is a branch location on the route on the map, the recommended lane determiner 61 determines a recommended lane such that the own vehicle M can travel on a reasonable route to advance to a branch destination.

The second map information 62 is map information with higher accuracy than that of the first map information 54. The second map information 62 includes, for example, information about the center of the lane or information about lane boundary. The second map information 62 may include road information, traffic regulation information, address information (address/postal code), facility information, telephone number information, and the like. The second map information 62 may be updated at any time by the communication device 20 performing communication with other devices.

The driver monitor camera 70 is, for example, a digital camera that uses a solid-state imaging sensor such as a CCD or a CMOS. The driver monitor camera 70 is attached to any position in the own vehicle M at a position and an orientation in which an occupant (that is, a driver) seated on a driver's seat of the own vehicle M can be imaged from the front. For example, the driver monitor camera 70 may be attached to the instrument panel IP of the own vehicle M.

The driving operator 80 includes, for example, an accelerator pedal, a brake pedal, a shift lever, and other operators in addition to a steering wheel 82. A sensor that detects an amount of operation or the presence or absence of operation is attached to the driving operator 80. A detection result from the sensor is output to the automated driving control device 100 or is output to some or all of the traveling drive force output device 200, the brake device 210, and the steering device 220.

The steering wheel 82 does not necessarily have to be annular and may have a form of an odd-shaped steering wheel, a joystick, a button, or the like. A steering grip sensor 84 is attached to the steering wheel 82. The steering grip sensor 84 is a capacitance sensor or the like. The steering grip sensor 84 detects whether or not the driver is gripping the steering wheel 82 (meaning that the driver is in contact with the steering wheel 82 in a state in which a force is being applied thereto), and outputs a signal indicating the detection result to the automated driving control device 100.

The automated driving control device 100 includes, for example, a first controller 120, a second controller 160, and a storage 180. Each of the first controller 120 and the second controller 160 is realized, for example, by a hardware processor such as a CPU executing a program (software). Some or all of the constituents may be realized by hardware (a circuit portion; including circuitry) such as an LSI, an ASIC, an FPGA, or a GPU, and may be realized by software and hardware in cooperation. The program may be stored in advance in a storage device (a storage device provided with a non-transitory storage medium) such as an HDD or a flash memory of the automated driving control device 100, and may be stored in an attachable and detachable storage medium such as a DVD or a CD-ROM and may be installed in the HDD or the flash memory of the automated driving control device 100 when the storage medium (non-transitory storage medium) is attached to a drive device.

The storage 180 is implemented by, for example, an HDD, a flash memory, an EEPROM, a ROM, a RAM, or the like. The storage 180 stores, for example, a program read and executed by a processor.

FIG. 4 is a functional configuration diagram of the first controller 120 and the second controller 160. The first controller 120 includes, for example, a recognizer 130, an action plan generator 140, and a mode controller 150. A combination of the action plan generator 140 and the second controller 160, or a combination of the action plan generator 140, the mode controller 150, and the second controller 160 is an example of a “driving controller”.

The first controller 120 is realized by combining, for example, a function of artificial intelligence (AI) with a function of a model provided in advance. For example, a function of “recognizing an intersection” may be realized by executing recognition of the intersection using deep learning and recognition based on conditions (for example, there are a signal that can be matched with a pattern, and a road marking) given in advance in parallel and scoring and comprehensively evaluating both of recognition results. Consequently, the reliability of automated driving is ensured.

The recognizer 130 recognizes situations or environments in the surroundings of the own vehicle M. For example, the recognizer 130 recognizes an object present in the surroundings of the own vehicle M on the basis of information input from the camera 10, the radar device 12, and the LIDAR 14 via the object recognition device 16. Objects recognized by the recognizer 130 include, for example, bicycles, motorcycles, four-wheeled vehicles, pedestrians, road signs, road markings, lane markings, utility poles, guardrails, and falling objects. The recognizer 130 recognizes states of the object such as a position, a speed, and an acceleration. The position of the object is recognized as, for example, a position (that is, a relative position with respect to the own vehicle M) in a relative coordinate system having a representative point (for example, the centroid or the drive axis center) of the own vehicle M as an origin and is used for control. The position of the object may be represented by a representative point such as the centroid or a corner of the object and may be represented by an expressed region. The “states” of the object may include an acceleration, a jerk, or an “action state” of the object (for example, whether or not the object is changing lanes or trying to change lanes).

The recognizer 130 recognizes, for example, a lane in which the own vehicle M is traveling (hereinafter, an own lane) and an adjacent lane that is adjacent to the own lane. For example, the recognizer 130 acquires the second map information 62 from the MPU 60, compares a pattern (for example, an arrangement of solid lines and dashed lines) of road lane markings included in the obtained second map information 62 with a pattern of road lane markings in the surroundings of the own vehicle M recognized from an image captured by the camera 10, and thus recognizes a space between the lane markings as an own lane or an adjacent lane.

The recognizer 130 is not limited to a road lane marking, and may recognize a boundary representing a lane boundary (road boundary) such as a road lane marking, a road shoulder, a curb, a median strip, and a guardrail, to recognize lanes such as an own lane or an adjacent lane. In this recognition, a position of the own vehicle M acquired from the navigation device 50 or a process result from an INS may be taken into consideration. The recognizer 130 recognizes a temporary stop line, an obstacle, a red light, a tollgate, or other road events.

When the own lane is recognized, the recognizer 130 recognizes a relative position and a posture of the own vehicle M with respect to the own lane. The recognizer 130 may recognize, for example, a deviation of a reference point of the own vehicle M from the lane center and an angle formed with a line connecting coordinate points of the lane centers in an advancing direction of the own vehicle M as a relative position and a posture of the own vehicle M with respect to the own lane. Alternatively, the recognizer 130 may recognize the reference point of the own vehicle M with respect to either of side ends (road lane markings or road boundaries) of the own lane as the relative position of the own vehicle M with respect to the own lane.

The action plan generator 140 generates target trajectories in which the own vehicle M automatedly (regardless of an operation of a driver) travels in the future in a state during traveling defined by an event that will be described later such that the own vehicle M can travel in a recommended lane determined by the recommended lane determiner 61 in principle and can also cope with a surrounding situation of the own vehicle M.

The target trajectory includes, for example, a speed element. For example, the target trajectory is expressed by sequentially arranging locations (trajectory points) to be reached by the own vehicle M. The trajectory points are locations to be reached by the own vehicle M every predetermined traveling distance (for example, about several [m]) in terms of a distance along a road, and, separately therefrom, a target speed and a target acceleration for each predetermined sampling time (for example, any of about 0.1 to 0.9 seconds) are generated as parts of the target trajectory. A trajectory point may be a position to be reached by the own vehicle M at a sampling time point every predetermined sampling time. In this case, information regarding the target speed or the target acceleration may be expressed by an interval between trajectory points.

The action plan generator 140 may generate a target trajectory in which the own vehicle M exceptionally travels in another lane different from a recommended lane (for example, a lane adjacent to the recommended lane) in order to cope with the surrounding situation of the own vehicle M. That is, a priority of other lanes other than the recommended lane is relatively lower than a priority of the recommended lane. For example, the recommended lane has the highest priority (priority 1), another lane (hereinafter, an adjacent lane) adjacent to the recommended lane has the second highest priority (priority 2), and still another adjacent lane that is adjacent to the adjacent lane has the third highest priority (priority 3). As described above, the action plan generator 140 generates a target trajectory in which the own vehicle M travels in the recommended lane having the highest priority in principle, and generates a target trajectory in which the own vehicle M exceptionally travels in another lane having a lower priority than that of the recommended lane depending on a surrounding situation of the own vehicle M.

The action plan generator 140 determines an automated driving event (including partial driving assistance) on a route where the recommended lane is determined when generating the target trajectory. The automated driving event is information defining a behavior that the own vehicle M has to take under automated driving (partial driving assistance), that is, the state during traveling (or a mode during traveling).

The automated driving event includes, for example, a constant speed traveling event, a low speed following traveling event, a lane change event, and a passing event. The constant speed traveling event is an event in which the own vehicle M travels in the same lane at a constant speed. The low speed following traveling event is an event in which the own vehicle M follows another vehicle (hereinafter, referred to as a preceding vehicle) that is present within a predetermined distance (for example, within 100 [m]) in front of the own vehicle M and is closest to the own vehicle M. The “following” may be, for example, a traveling state in which a relative distance (inter-vehicle distance) between the own vehicle M and the preceding vehicle is kept constant, or a traveling state in which the own vehicle M travels in the center of the own lane in addition to keeping the relative distance between the own vehicle M and the preceding vehicle constant. The lane change event is an event in which the own vehicle M changes from the own lane to an adjacent lane. The passing event is an event in which the own vehicle M temporarily changes to an adjacent lane, passes the preceding vehicle in the adjacent lane, and then performs a lane change from the adjacent lane to the original lane again.

The automated driving event further includes a branching event, a merging event, a lane reduction event, a takeover event, and the like. The branching event is an event in which, in a case where the own vehicle M is traveling in a main lane and a destination thereof is located on an extension of a branch line (hereinafter, a branch lane) branched from the main lane, the own vehicle M is guided to change from the main lane to the branch lane at a branch location. The merging event is an event in which, in a case where the own vehicle M is traveling on a branch line (hereinafter, a merging lane) which merges into a main lane and a destination thereof is located on an extension of the main lane, the own vehicle M is guided to change from the merging lane to the main lane at a merging location. The lane reduction event is an event in which the own vehicle M changes to another lane when traveling on a route in which the number of lanes is decreasing on the way. The takeover event is an event for finishing an automated driving mode (a mode A that will be described later) and switching to a driving assistance mode (modes B, C, and D that will be described later) or a manual driving mode (a mode E that will be described later), or finishing the driving assistance mode (modes B, C, and D) and switching to the manual driving mode (mode E). For example, a lane marking may be interrupted in front of a tollhouse on an expressway, and a relative position of the own vehicle M may not be recognized. In such a case, the takeover event is determined (planned) for a section in front of the tollhouse.

The action plan generator 140 sequentially determines these plurality of events on the route to the destination, and generates a target trajectory for causing the own vehicle M to travel in a state defined by each event while considering a surrounding situation of the own vehicle M.

The mode controller 150 determines a driving mode of the own vehicle M to be one of a plurality of driving modes. The plurality of driving modes respectively have different tasks imposed on a driver. The mode controller 150 includes, for example, a driver state determiner 152, a mode determiner 154, and a device controller 156. Individual functions thereof will be described later. A combination of the driver monitor camera 70 and the driver state determiner 152 is an example of a “detector”. A combination of the action plan generator 140 and the driver state determiner 152 is an example of a “determiner”. The device controller 156 is an example of a “display controller”.

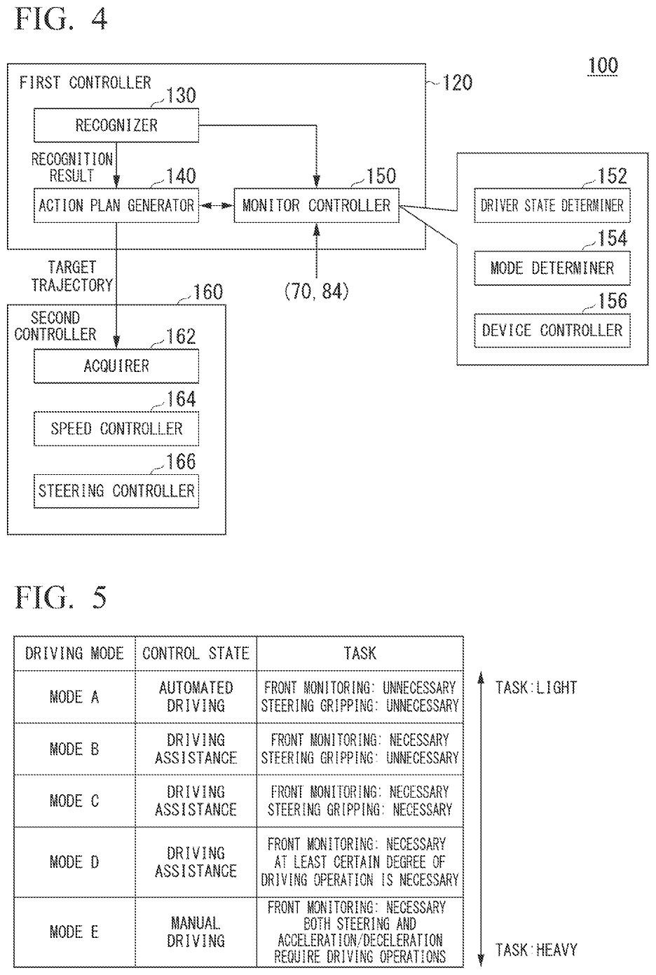

FIG. 5 is a diagram showing an example of a correspondence relationship between a driving mode, a control state of the own vehicle M, and a task. Driving modes of the own vehicle M include, for example, five modes from the mode A to the mode E. A control state, that is, the degree of automation (control level) of driving control for the own vehicle M is highest in the mode A, then becomes lower in the order of the mode B, the mode C, and the mode D, and is lowest in the mode E. In contrast, a task imposed on a driver is lightest in the mode A, then becomes heavier in the order of the mode B, the mode C, and the mode D, and is heaviest in the mode E. In the modes D and E, the vehicle is in a control state that is not automated driving, and thus the automated driving control device 100 is responsible for finishing control related to automated driving and transitioning to driving assistance or manual driving. Hereinafter, details of each driving mode will be exemplified.

In the mode A, the vehicle is in an automated driving state, and neither front monitoring nor gripping of the steering wheel 82 (steering gripping in the figure) is imposed on the driver. However, even in the mode A, the driver is required to be in a posture to quickly transition to manual driving in response to a request from the system centered on the automated driving control device 100. The term “automated driving” referred to here means that both steering and acceleration/deceleration are controlled without depending on the driver's operation. The term “front” means a space in an advancing direction of the own vehicle M that is visually recognized through the front windshield. The mode A is a driving mode that is executable in a case of satisfying a condition that the own vehicle M is traveling at a predetermined speed (for example, about 50 [km/h]) or less on a motorway such as an expressway and there is a preceding vehicle that is a following target and may be referred to as traffic jam pilot (TJP). In a case where this condition is no longer satisfied, the mode controller 150 changes driving modes to the mode B.

In the mode B, the vehicle is in a driving assistance state, and the task of monitoring the front in the own vehicle M (hereinafter, front monitoring) is imposed on the driver, but the task of gripping the steering wheel 82 is not imposed on the driver. In the mode C, the vehicle is in a driving assistance state, and the task of front monitoring and the task of gripping the steering wheel 82 are imposed on the driver. The mode D is a driving mode that requires a certain degree of driving operation by the driver with respect to at least one of steering and acceleration/deceleration of the own vehicle M. For example, in the mode D, driving assistance such as adaptive cruise control (ACC) or lane keeping assist system (LKAS) is provided. In the mode E, the vehicle is in a manual operation state in which both steering and acceleration/deceleration require driving operations by the driver. In both the mode D and the mode E, the task of monitoring the front in the own vehicle M is naturally imposed on the driver.

The automated driving control device 100 (and a driving assistance device (not shown)) executes an automated lane change according to a driving mode. The automated lane change includes an automated lane change (1) according to a system request and an automated lane change (2) according to a driver request. The automated lane change (1) includes an automated lane change for passing in a case where a speed of a preceding vehicle is lower than a speed of the own vehicle by a reference or more and an automated lane change for advancing toward a destination (an automated lane change due to changing to a recommended lane). The automated lane change (2) is to change lanes toward an operation direction when the direction indicator is operated by the driver in a case where conditions related to a speed or a positional relationship with surrounding vehicles are satisfied.

The automated driving control device 100 does not execute either the automated lane change (1) or (2) in the mode A. The automated driving control device 100 executes both the automated lane change (1) and (2) in modes B and C. The driving assistance device (not shown) does not execute the automated lane change (1) but executes the automated lane change (2) in the mode D. In the mode E, neither automated lane change (1) nor (2) is executed.

FIG. 4 will be referred to again. With respect to the own vehicle M, the mode controller 150 changes driving modes to a driving mode in which the task is heavier when the task related to the determined driving mode is not executed by the driver.

For example, in the mode A, when the driver cannot transition to manual driving in response to a request from the system (for example, when the driver continues to look outside a permissible area or a sign that driving becomes difficult is detected), the mode controller 150 uses the HMI 30 to prompt the driver to transition to manual driving, and if the driver does not respond, the mode controller 150 performs control of gradually bringing the own vehicle M to a road shoulder and stopping the own vehicle M to stop the automated driving. After the automated driving is stopped, the own vehicle is in the mode D or E, and the own vehicle M can be started by a manual operation of the driver. Hereinafter, the same applies to “stop automated driving”. If the driver is not monitoring the front in the mode B, the mode controller 150 uses the HMI 30 to prompt the driver to monitor the front, and if the driver does not respond, the mode controller 150 performs control of gradually bringing the own vehicle M to a road shoulder and stopping the own vehicle M to stop the automated driving. In the mode C, if the driver is not monitoring the front or is not gripping the steering wheel 82, the mode controller 150 uses the HMI 30 to prompt the driver to monitor the front and/or grip the steering wheel 82, and if the driver does not respond, the mode controller 150 performs control of gradually bringing the own vehicle M to a road shoulder and stopping the own vehicle M to stop the automated driving.

The driver state determiner 152 determines whether or not the driver is able to perform a task on the basis of an image from the driver monitor camera 70 and a detection signal from the steering grip sensor 84 in order to perform the above mode change.

For example, the driver state determiner 152 analyzes the image from the driver monitor camera 70 to estimate a posture of the driver and determines whether or not the driver is able to transition to manual driving in response to a request from the system on the basis of the estimated posture.

The driver state determiner 152 analyzes the image from the driver monitor camera 70 to estimate an orientation of the driver's line of sight or face and determines whether or not the driver is monitoring the front in the own vehicle M on the basis of the estimated orientation of the line of sight or the face (hereinafter, referred to as a line-of-sight direction). The line-of-sight direction is an example of a “first direction”.

For example, the driver state determiner 152 detects a positional relationship between the driver's head and eyes, a combination of a reference point and a moving point in the eyes, and the like from the image from the driver monitor camera 70 by using a technique such as template matching. The driver state determiner 152 estimates the orientation of the face on the basis of a relative position of the eyes with respect to the head. The driver state determiner 152 estimates the orientation of the driver's line of sight on the basis of a position of the moving point with respect to the reference point. For example, in a case where the reference point is the inner corner of the eye, the moving point is the iris. In a case where the reference point is the corneal reflex region, the moving point is the pupil.

The driver state determiner 152 determines whether or not the driver is gripping the steering wheel 82 on the basis of the detection signal from the steering grip sensor 84.

The mode determiner 154 determines a driving mode of the own vehicle M according to the determination result from the driver state determiner 152.

The device controller 156 controls an in-vehicle device such as the HMI 30 on the basis of the driving mode of the own vehicle M determined by the mode determiner 154 and the determination result from the driver state determiner 152. For example, the device controller 156 uses the HMI 30 to output information for prompting the driver to perform a task corresponding to each driving mode or to output information for guiding the driver's line of sight.

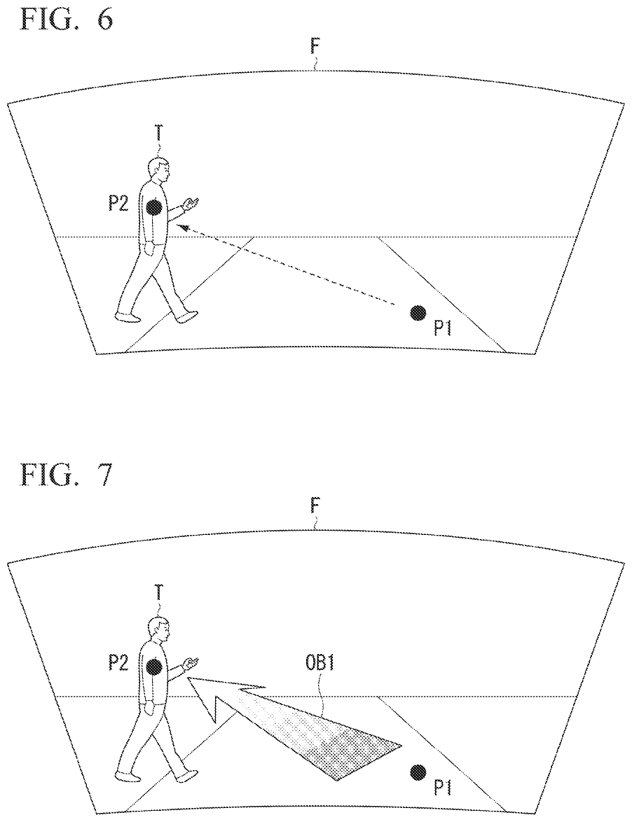

FIGS. 6 and 7 are diagrams for describing a method of guiding the driver's line of sight. In the figure, F represents the front window shield, P1 represents a line-of-sight position of the driver, and P2 represents a representative position of a target object T to be watched by the driver (for example, center coordinates of the target object T).

For example, it is assumed that the driver directs his/her line of sight to the front window shield F or the instrument panel IP below it (including the instrument panel display 32B installed in the instrument panel IP, the display meter 32C, and the center display 32D). In this case, vectors representing the driver's line-of-sight direction (hereinafter, referred to as line-of-sight vectors) intersect each other at one point on the front window shield F or the instrument panel IP. That is, the driver's line-of-sight position P1 is an intersection where the line-of-sight vectors intersect on a surface (a surface inside the vehicle) of an interior member such as the front window shield F or the instrument panel IP. In the illustrated example, the driver's line-of-sight position P1 is an intersection of the line-of-sight vectors on the front window shield F.

The position P2 of the target object T is an intersection where vectors (hereinafter, referred to as target vectors) representing a direction in which the target object T is present when viewed from the driver intersect on the front window shield F. The direction in which the target object T is present is an example of a “second direction”.

For example, the device controller 156 calculates a linear path from P1 to P2. That is, the device controller 156 calculates a movement path of the line of sight from the current line-of-sight direction of the driver to the direction in which the target object T is present. When the device controller 156 calculates the path, the device controller 156 selects one or a plurality of displays present on the calculated path or closest to the path from among the HUD 32A, the instrument panel display 32B, the display meter 32C, and the center display 32D, and displays a line-of-sight guidance object OB1 on one or more of the selected displays.

The line-of-sight guidance object OB1 is a display object for guiding the driver's line of sight toward the target object T. As shown in the figure, the line-of-sight guidance object OB1 may be an arrow indicating the target object T (P2). The arrow may be displayed in gradation such that a color becomes lighter as the distance to the target object T becomes shorter. The line-of-sight guidance object OB1 is an example of “first information”.

For example, in a case where the driver's line of sight is directed to the scenery through the front window shield F, P1 is on the screen of the HUD 32A. In this case, only the HUD 32A is present on the linear path (the movement path of the line of sight) from P1 to P2. For example, the device controller 156 selects the HUD 32A from among the four displays and displays the line-of-sight guidance object OB1 on the selected HUD 32A.

For example, in a case where the driver's line of sight is directed to the center display 32D, P1 is on the screen of the center display 32D. In this case, at least the center display 32D and the HUD 32A are present on the linear path (the movement path of the line of sight) from P1 to P2. For example, the device controller 156 selects the center display 32D and the HUD 32A from among the four displays, and first displays the line-of-sight guidance object OB1 on the center display 32D close to P1 of the two selected displays, and then displays line-of-sight guidance object OB1 on the HUD 32A. As described above, by displaying the line-of-sight guidance object OB1 on the display in order along the movement path of the line of sight, the driver's attention can be more attracted to the target object.

The device controller 156 may change a display mode of the line-of-sight guidance object OB1 on the basis of a line-of-sight direction of the driver and a direction in which the target object T is present.

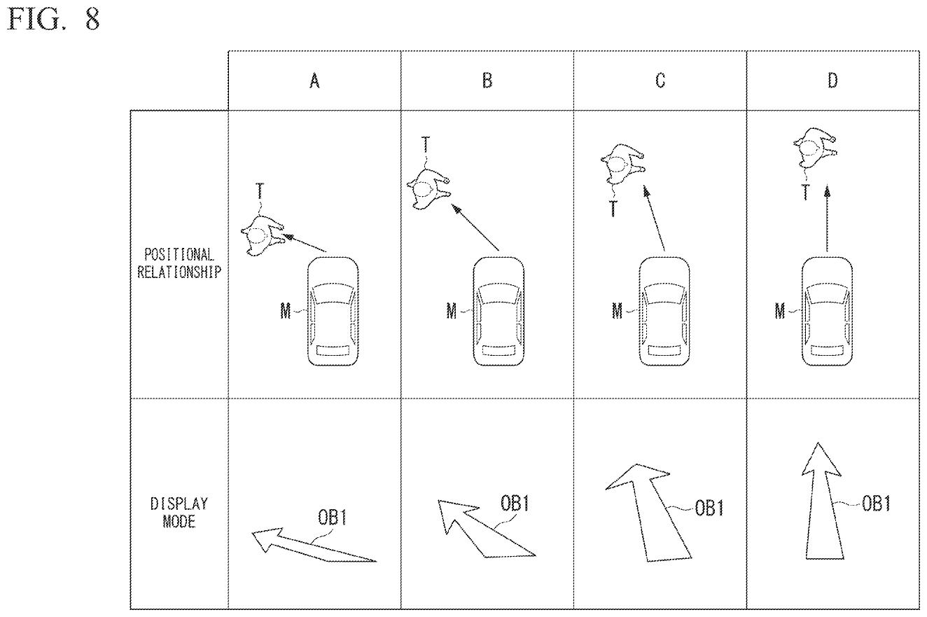

FIG. 8 is a diagram showing an example of a display mode of the line-of-sight guidance object OB1. In the illustrated example, relative positions of the target object T with respect to the own vehicle M are different in each of scenes A, B, C, and D. In such a case, the movement path of the driver's line of sight to reach the target object T differs from scene to scene. Therefore, the device controller 156 may change a display position, a shape, a color, a shading, or the like of the line-of-sight guidance object OB1 according to each scene.

FIG. 4 will be referred to again. The second controller 160 controls the traveling drive force output device 200, the brake device 210, and the steering device 220 such that the own vehicle M can pass along the target trajectory generated by the action plan generator 140 as scheduled.

The second controller 160 includes, for example, an acquirer 162, a speed controller 164, and a steering controller 166. The acquirer 162 acquires information regarding the target trajectory (trajectory point) generated by the action plan generator 140 and stores the information in a memory (not shown). The speed controller 164 controls the traveling drive force output device 200 or the brake device 210 on the basis of a speed element included in the target trajectory stored in the memory. The steering controller 166 controls the steering device 220 according to a curved state of the target trajectory stored in the memory. Processes in the speed controller 164 and the steering controller 166 are realized by a combination of, for example, feedforward control and feedback control. As an example, the steering controller 166 executes a combination of feedforward control based on a curvature of a road in front of the own vehicle M and feedback control based on deviation from the target trajectory.

The traveling drive force output device 200 outputs traveling drive force (torque) for traveling of the vehicle to drive wheels. The traveling drive force output device 200 includes, for example, a combination of an internal combustion engine, a motor, and a transmission, and an electronic control unit (ECU) controlling the constituents. The ECU controls the constituents according to information that is input from the second controller 160 or information that is input from the driving operator 80.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor on the basis of information being input from the second controller 160 or information being input from the driving operator 80, so that brake torque corresponding to a braking operation is output to each vehicle wheel. The brake device 210 may include, as a backup, a mechanism transmitting hydraulic pressure generated by operating the brake pedal included in the driving operator 80, to the cylinder via a master cylinder. The brake device 210 is not limited to the above configuration and may be an electronic control type hydraulic brake device that controls an actuator according to information being input from the second controller 160 and thus transmits hydraulic pressure in a master cylinder to the cylinder.

The steering device 220 includes, for example, a steering ECU and an electric motor. The electric motor changes an orientation of a turning wheel by applying force to, for example, a rack-and-pinion mechanism. The steering ECU drives the electric motor on the basis of information being input from the second controller 160 or information being input from the driving operator 80, so that an orientation of the turning wheel is changed.

Overall Process Flow

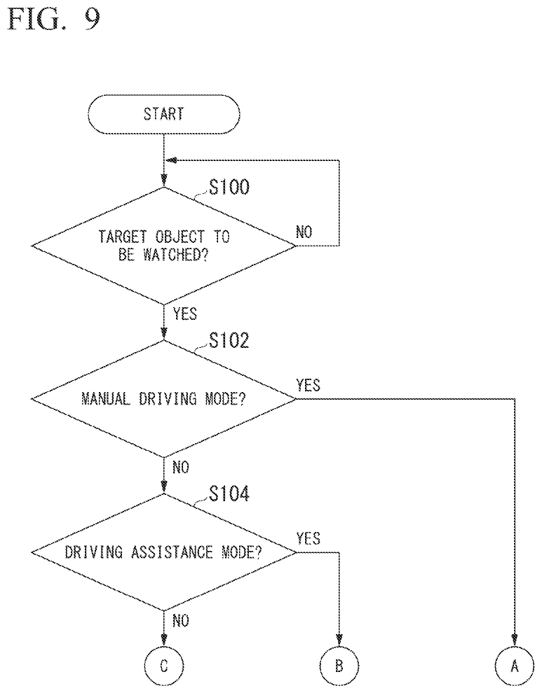

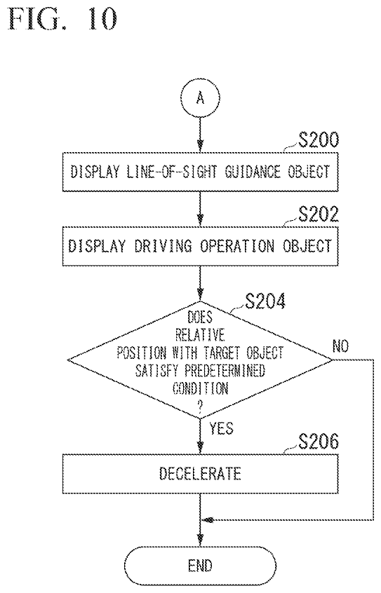

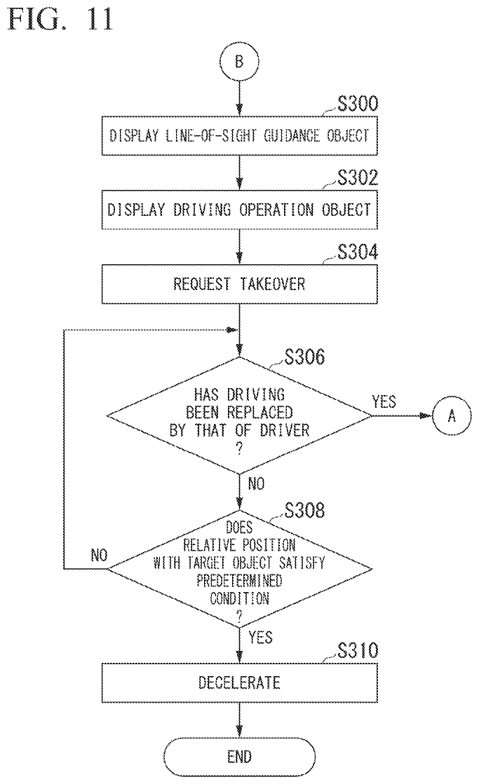

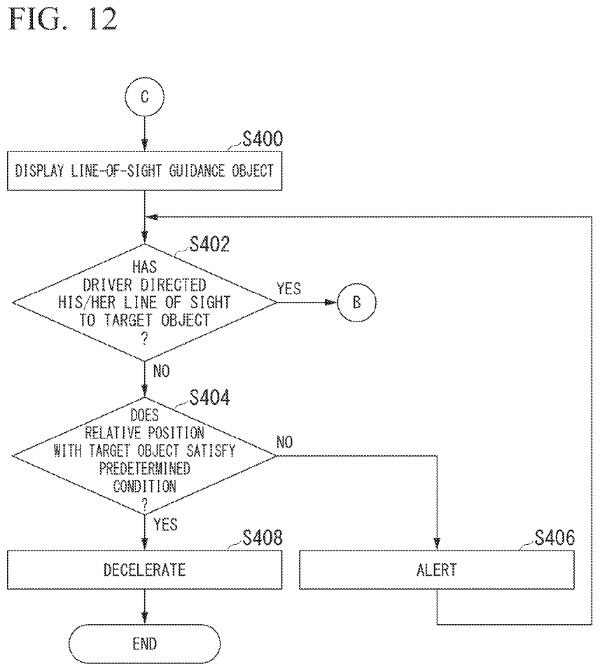

Hereinafter, a flow of a series of processes in the automated driving control device 100 of the embodiment will be described with reference to a flowchart. FIGS. 9 to 12 are flowcharts showing an example of a flow of a series of processes in the automated driving control device 100 of the embodiment.

First, the action plan generator 140 determines whether or not the target object T to be watched by a driver is included in one or a plurality of objects recognized by the recognizer 130 (step S100).

For example, the action plan generator 140 determines whether or not the object recognized by the recognizer 130 is the target object T to be watched by the driver on the basis of a state of the object such as the position, the speed, or the acceleration and the traveling status of the own vehicle M such as “turning right,” “turning left,” or “going straight.” More specifically, the action plan generator 140 determines that a pedestrian or a two-wheeled vehicle (an object that is easily caught) present on the side of the own vehicle M when turning right or left is the target object T to be watched by the driver, or determines that a pedestrian or the like who is trying to cross a road in front of the own vehicle M when going straight is the target object T to be watched by the driver.

In a case where the target object T to be watched by the driver is included in one or more objects recognized by the recognizer 130, the action plan generator 140 determines whether or not the driving mode of the own vehicle M is the manual driving mode (mode E) (step S102).

In a case where a driving mode of the own vehicle M is the manual driving mode (mode E), the action plan generator 140 causes the process to proceed to S200 (proceed to the flow of A in the figure).

On the other hand, when the driving mode of the own vehicle M is not the manual driving mode (mode E), the action plan generator 140 further determines whether the driving mode of the own vehicle M is the driving assistance mode (modes B, C, and D) (step S104).

In a case where the driving mode of the own vehicle M is the driving assistance mode (modes B, C, and D), the action plan generator 140 causes the process to proceed to S300 (the process proceeds to the flow of B in the figure).

In a case where the driving mode of the own vehicle M is not the driving assistance mode (modes B, C, and D), that is, in a case where the driving mode of the own vehicle M is the automated driving mode (mode A), the action plan generator 140 causes the process to proceed to S400 (the process proceeds to the flow of C in the figure).

Flow Under Manual Driving Mode

In a case where the driving mode of the own vehicle M is the manual driving mode (mode E), the device controller 156 displays the line-of-sight guidance object OB1 on the HMI 30 on the basis of a line-of-sight direction of the driver and a direction in which the target object T is present when viewed from the driver (step S200).

As described above, the device controller 156 may calculate a movement path of the line of sight from the current line-of-sight direction of the driver to the direction in which the target object T is present, select one or a plurality of displays present on the calculated path or close to the path from among the HUD 32A, the instrument panel display 32B, the display meter 32C, and the center display 32D, and display the line-of-sight guidance object OB1 on the selected one or more displays. The device controller 156 may change a display mode of the line-of-sight guidance object OB1 on the basis of the line-of-sight direction of the driver and the direction in which the target object T is present.

Next, the device controller 156 displays a driving operation object OB2 on the HMI 30 (step S202). The driving operation object OB2 is a display object for notifying the driver of a driving operation to be performed by the driver under the manual driving mode. The driving operation object OB2 is an example of “second information”.

FIG. 13 is a diagram showing examples of the line-of-sight guidance object OB1 and the driving operation object OB2. For example, in a case where the target object T is present on the upper left side from a position where the driver's line of sight is directed, the line-of-sight guidance object OB1 is an arrow indicating the upper left side. Since the target object T is on the left side, it is preferable to steer the own vehicle M to the right side. Therefore, as shown in the figure, the device controller 156 displays the driving operation object OB2 that guides the driver to turn the steering wheel 82 to the right side.

Next, the action plan generator 140 determines whether or not a relative positional relationship between the own vehicle M and the target object T satisfies a predetermined condition (step S204). The predetermined condition is a condition in which the own vehicle M and the target object T are spatially or temporally close to each other to the extent that the situation can be regarded to be urgent.

For example, the action plan generator 140 may determine that the predetermined condition is satisfied in a case where a relative distance between the own vehicle M and the target object T is less than a first threshold value and may determine that the predetermined condition is not satisfied in a case where the relative distance is equal to or more than the first threshold value.

The action plan generator 140 may determine that the predetermined condition is satisfied in a case where a relative speed between the own vehicle M and the target object T is equal to or more than a second threshold value and may determine that the predetermined condition is not satisfied in a case where the relative speed is less than the second threshold value.

The action plan generator 140 may determine that the predetermined condition is satisfied in a case where time to collision (TTC) between the own vehicle M and the target object T is less than a third threshold value and may determine that the predetermined condition is not satisfied in a case where TTC is equal to or more than the third threshold value.

When it is determined that the predetermined condition is satisfied, the action plan generator 140 generates a target trajectory for decelerating the own vehicle M. In response to this, the second controller 160 controls a speed of the own vehicle M on the basis of the target trajectory to decelerate and stop the own vehicle M (step S206).

On the other hand, when it is determined that the predetermined condition is not satisfied, the action plan generator 140 skips the process in S206 is skipped and finishes the process in this flowchart.

Flow under driving assistance mode In a case where a driving mode of the own vehicle M is the driving assistance mode (modes B, C, and D), the device controller 156 displays the line-of-sight guidance object OB1 on the HMI 30 on the basis of the line-of-sight direction of the driver and the direction in which the target object T is present when viewed from the driver in the same as in the process in S200 (step S300).

Next, the device controller 156 displays the driving operation object OB2 on the HMI 30 (step S302).

Next, the device controller 156 requests the driver to perform takeover by using the HMI 30 (step S304).

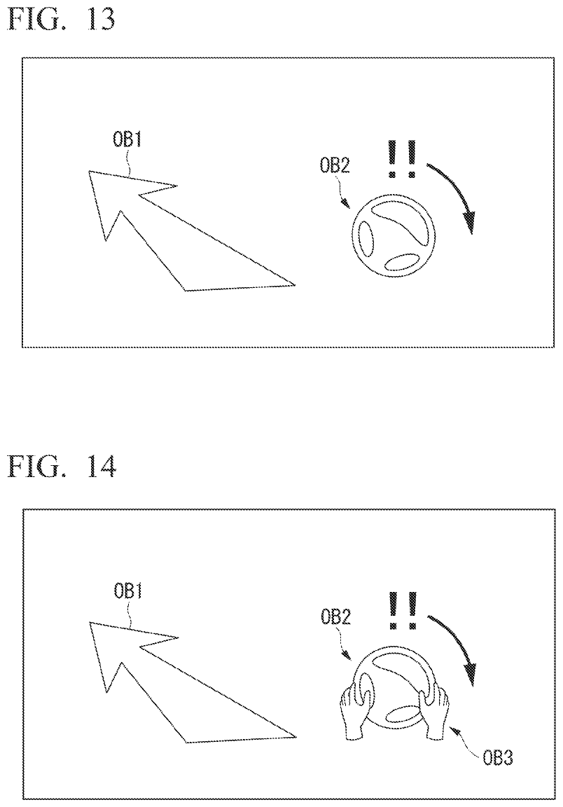

FIG. 14 is a diagram showing an example of a takeover request. As shown in the figure, the device controller 156 superimposes and displays a display object OB3 representing the driver's hand on an image of the steering wheel 82 displayed as the driving operation object OB2 at the time of the takeover request. In this case, the device controller 156 may output a sound for requesting takeover via the speaker of the HMI 30. The display object OB3 representing the driver's hand is an example of “third information”.

Next, the action plan generator 140 determines whether or not the driving of the own vehicle M has been replaced by that of the driver in response to the takeover request (step S306). For example, the action plan generator 140 may determine that the driving of the own vehicle M has been replaced by that of the driver in a case where the driver state determiner 152 determines that the driver is monitoring the front in the own vehicle M and the driver is gripping the steering wheel 82 after the takeover request.

in a case where it is determined that the driving of the own vehicle M has been replaced by that of the driver, the action plan generator 140 causes the process to proceed to S200 (the process proceeds to the flow of A in the figure).

On the other hand, in a case where it is determined that the driving of the own vehicle M has not been replaced by that of the driver, the action plan generator 140 determines whether or not a relative positional relationship between the own vehicle M and the target object T satisfies a predetermined condition (step S308).

When it is determined that the predetermined condition is not satisfied, the action plan generator 140 returns the process to S306, and determines again whether or not the driving of the own vehicle M has been replaced by that of the driver.

On the other hand, when it is determined that the predetermined condition is satisfied, the action plan generator 140 generates a target trajectory for decelerating the own vehicle M. In response to this, the second controller 160 controls a speed of the own vehicle M on the basis of the target trajectory to decelerate and stop the own vehicle M (step S310). Consequently, the process in this flowchart is finished.

Flow Under Automated Driving Mode

In a case where a driving mode of the own vehicle M is the automated driving mode (mode A), the device controller 156 displays the line-of-sight guidance object OB1 on the HMI 30 on the basis of the line-of-sight direction of the driver and the direction in which the target object T is present when viewed from the driver in the same as in the process in S200 or S300 (step S400).

Next, the driver state determiner 152 estimates the line-of-sight direction of the driver from an image captured by the driver monitor camera 70 after the line-of-sight guidance object OB1 is displayed and determines whether or not the line of sight is directed to the target object T to be watched by the driver on the basis of the estimated line-of-sight direction (step S402).

For example, the driver state determiner 152 may determine that the line of sight is directed to the target object T to be watched by the driver when an angle formed between a line-of-sight vector that is a vector in the line-of-sight direction of the driver and a target vector that is a vector in the direction in which the target object T is present is less than a fourth threshold value, and may determine that the line of sight is not directed to the target object T to be watched by the driver when the angle is equal to or more than the fourth threshold value.

In a case where it is determined that the line of sight is directed to the target object T to be watched by the driver, the driver state determiner 152 causes the process to proceed to S300 (the process proceeds to the flow of B in the figure).

On the other hand, in a case where it is determined that the line of sight is not directed to the target object T to be watched by the driver, the action plan generator 140 determines whether or not a relative positional relationship between the own vehicle M and the target object T satisfies a predetermined condition (step S404).

When it is determined that the predetermined condition is not satisfied, the device controller 156 alerts the driver by using the HMI 30 (step S406), and then returns the process to S402.

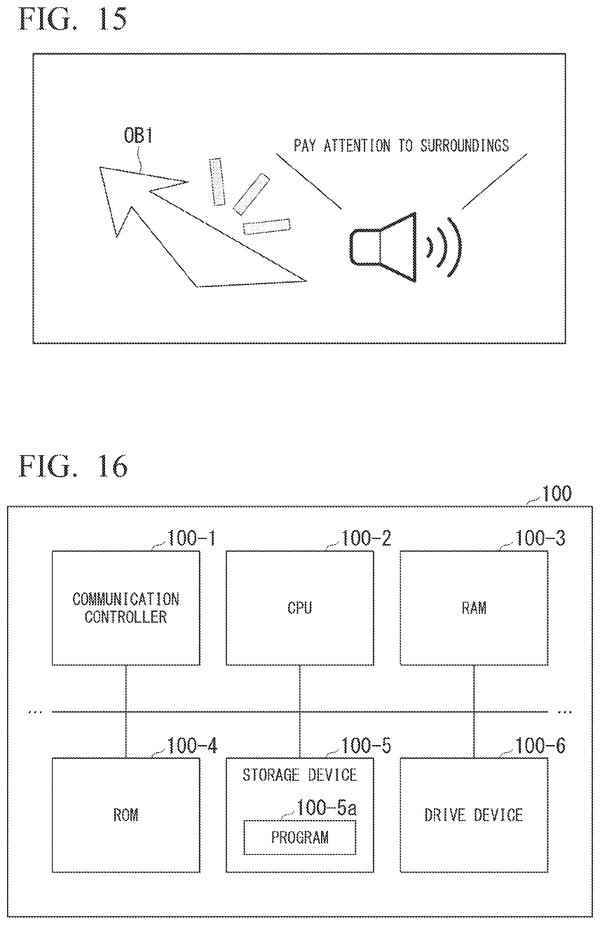

FIG. 15 is a diagram showing an example of alerting. As shown in the figure, for example, the device controller 156 flashes an arrow displayed as the line-of-sight guidance object OB1 on the display of the HMI 30, or outputs a voice for alerting the driver from the speaker of the HMI 30.

When it is determined that the predetermined condition is satisfied, the action plan generator 140 generates a target trajectory for decelerating the own vehicle M. In response to this, the second controller 160 controls a speed of the own vehicle M on the basis of the target trajectory to decelerate and stop the own vehicle M (step S408). Consequently, the process in this flowchart is finished.

In the above description of the flowcharts, the case where the number of target objects T to be watched by the driver is one has been described, but the present invention is not limited to this. For example, in a case where there is a plurality of target objects T to be watched by the driver, the device controller 156 may select target objects T a predetermined number K having a higher probability of collision with the own vehicle M spatially or temporally from among the plurality of target objects T. K is any natural number. When the device controller 156 selects the target objects T of the predetermined number K, the device controller 156 displays the line-of-sight guidance object OB1 indicating a direction of each of the selected target objects T. As described above, the target object T of which the direction is indicated by the line-of-sight guidance object OB1 may be selected on the basis of the probability of collision with the own vehicle M.

The device controller 156 may display while switching the line-of-sight guidance object OB1 according to a surrounding situation of the own vehicle M. For example, an object that is the target object T to be watched by the driver at certain time t1 may not be the target object T at the next time t2, or the probability of collision may decrease. In such a case, an object handled as the target object T changes from moment to moment. In a case where the target object T switches from moment to moment, the device controller 156 may display the line-of-sight guidance object OB1 in accordance with the switching target object T. In this case, the device controller 156 may display the line-of-sight guidance object OB1 with hysteresis.

According to the embodiment described above, the automated driving control device 100 displays, in a case where the target object T to be watched by the driver is present in the surroundings of the own vehicle M, the line-of-sight guidance object OB1 for guiding the driver's line of sight toward the target object T on one or a plurality of displays included in the HMI 30 on the basis of a line-of-sight direction of the driver and a direction in which the target object T is present when viewed from the driver. The automated driving control device 100 determines at least one display to display the line-of-sight guidance object OB1 from among the plurality of displays on the basis of the line-of-sight direction of the driver or determines a mode of the line-of-sight guidance object OB1 to be displayed on the display. As a result, the driver can directly direct his/her line of sight to the target object T without directing the line of sight in any other direction from a direction in which the line of sight is currently directed. As a result, the driver can check the target object T more quickly and can thus drive the own vehicle M more safely.

Hardware Configuration

FIG. 16 is a diagram showing an example of a hardware configuration of the automated driving control device 100 of the embodiment. As shown in FIG. 16, the automated driving control device 100 is configured to include a communication controller 100-1, a CPU 100-2, a RAM 100-3 used as a working memory, a ROM 100-4 storing a boot program or the like, a storage device 100-5 such as a flash memory or an HDD, and a drive device 100-6 that are connected to each other via an internal bus or a dedicated communication line. The communication controller 100-1 performs communication with constituents other than the automated driving control device 100. The storage device 100-5 stores a program 100-5a executed by the CPU 100-2. The program is loaded to the RAM 100-3 by a direct memory access (DMA) controller (not shown) or the like and is executed by the CPU 100-2. Consequently, at least one of the first controller 120 and the second controller 160 is realized.

The embodiment described above may be expressed as follows.

A driving assistance device including:

a storage medium storing computer-readable instructions; and

a processor connected to the storage medium,

in which the processor executes the computer-readable instructions to be configured to

recognize a state of a surrounding object that is an object present in the surroundings of a vehicle and a traveling status of the vehicle,

detect a first direction that is a direction of a line of sight of a driver of the vehicle,

determine whether or not the surrounding object is a target object to be watched by the driver on the basis of the state of the surrounding object and the traveling status,

In a case where it is determined that the surrounding object is the target object, display first information for guiding the line of sight of the driver toward the target object on one or a plurality of displays on the basis of the first direction and a second direction in which the target object is present when viewed from the driver, and

determine at least one display to display the first information from among the plurality of displays or determine a mode of the first information to be displayed on the display on the basis of the first direction.

As mentioned above, the mode for carrying out the present invention has been described by using the embodiment, but the present invention is not limited to the embodiment, and various modifications and replacements may occur within the scope without departing from the spirit of the present invention.

What is claimed is:

1. A driving assistance device comprising:
a recognizer that recognizes a state of a surrounding object that is an object present in the surroundings of a vehicle and a traveling status of the vehicle;
a detector that detects a first direction that is a direction of a line of sight of a driver of the vehicle;
a determiner that determines whether or not the surrounding object is a target object to be watched by the driver on the basis of the state of the surrounding object and the traveling status recognized by the recognizer; and
a display controller that, in a case where the determiner determines that the surrounding object is the target object, displays first information for guiding the line of sight of the driver toward the target object on one or a plurality of displays on the basis of the first direction detected by the detector and a second direction in which the target object is present when viewed from the driver,
wherein the display controller determines at least one display to display the first information from among the plurality of displays or determines a mode of the first information to be displayed on the display on the basis of the first direction detected by the detector.

2. The driving assistance device according to claim 1,
wherein the display controller determines the at least one display to display the first information from among the plurality of displays or determines the mode of the display to be displayed on the display on the basis of a movement path of the line of sight from the first direction to the second direction.

3. The driving assistance device according to claim 1,
wherein, in a case where the driving mode of the vehicle is the manual driving mode, the display controller displays the first information and second information for notifying the driver of a manual driving operation to be performed by the driver on the display.

4. The driving assistance device according to claim 1,
wherein, in a case where the driving mode of the vehicle is a driving assistance mode in which the driver is required to monitor the front in the vehicle, the display controller displays the first information, second information for notifying the driver of a manual driving operation to be performed by the driver, and third information for requesting the driver to drive the vehicle on the display.

5. The driving assistance device according to claim 1,
wherein, in a case where the driving mode of the vehicle is an automated driving mode in which the driver is not required to monitor the front in the vehicle, the display controller displays the first information on the display, and
wherein, in a case where the driving mode of the vehicle is the automated driving mode, the determiner determines whether or not the driver has directed his/her line of sight to the target object on the basis of the first direction detected by the detector after the first information is displayed on the display and the second direction.

6. The driving assistance device according to claim 5, further comprising:
a driving controller that controls at least one of a speed and steering of the vehicle,
wherein, under the automated driving mode, in a case where the determiner determines that the driver has not directed his/her line of sight to the target object and a relative positional relationship between the vehicle and the target object satisfies a predetermined condition, the driving controller decelerates the vehicle.

7. The driving assistance device according to claim 5,
wherein, under the automated driving mode, in a case where the determiner determines that the driver has directed his/her line of sight to the target object, the display controller displays the first information, second information for notifying the driver of a manual driving operation to be performed by the driver, and third information for requesting the driver to drive the vehicle on the display.

8. The driving assistance device according to claim 4, further comprising:
a driving controller that controls at least one of a speed and steering of the vehicle,
wherein, in a case where driving of the vehicle is not replaced by that of the driver after the third information is displayed on the display, and a relative positional relationship between the vehicle and the target object satisfies a predetermined condition, the driving controller decelerates the vehicle.

9. The driving assistance device according to claim 8,
wherein, in a case where the driving of the vehicle is replaced by that of the driver after the third information is displayed on the display, the display controller displays the first information and the second information on the display.

10. The driving assistance device according to claim 3, further comprising:
a driving controller that controls at least one of a speed and steering of the vehicle,
wherein, in a case where a relative positional relationship between the vehicle and the target object satisfies a predetermined condition after the first information and the second information are displayed on the display, the driving controller decelerates the vehicle.

11. A driving assistance method of causing a computer mounted on a vehicle to:
recognize a state of a surrounding object that is an object present in the surroundings of the vehicle and a traveling status of the vehicle;
detect a first direction that is a direction of a line of sight of a driver of the vehicle;
determine whether or not whether or not the surrounding object is a target object to be watched by the driver on the basis of the state of the surrounding object and the traveling status;
in a case where it is determined that the surrounding object is the target object, display first information for guiding the line of sight of the driver toward the target object on one or a plurality of displays on the basis of the first direction and a second direction in which the target object is present when viewed from the driver; and
determine at least one display to display the first information from among the plurality of displays on the basis of the first direction or determine a mode of the first information to be displayed on the display.

12. A non-transitory storage medium storing computer-readable instructions for causing a computer mounted on a vehicle to execute:
recognizing a state of a surrounding object that is an object present in the surroundings of the vehicle and a traveling status of the vehicle;
detecting a first direction that is a direction of a line of sight of a driver of the vehicle;
determining whether or not whether or not the surrounding object is a target object to be watched by the driver on the basis of the state of the surrounding object and the traveling status;
in a case where it is determined that the surrounding object is the target object, displaying first information for guiding the line of sight of the driver toward the target object on one or a plurality of displays on the basis of the first direction and a second direction in which the target object is present when viewed from the driver; and
determining at least one display to display the first information from among the plurality of displays on the basis of the first direction or determining a mode of the first information to be displayed on the display.
